(19) United States
(12) Patent Application Publication
(10) Pub. No.: US 2014/0064541 A1
(43) Pub. Date: Mar. 6, 2014

(54) Wrist Band and Other Portable Loudspeakers and Electronic Apparatus Utilizing Same

(71) Applicant: DR. G LICENSING, LLC, (US)

(72) Inventor: Godehard Guenther, Reno, NV (US)

(73) Assignee: DR. G LICENSING, LLC, Reno, NV (US)

(21) Appl. No.: 13/835,844

(22) Filed: Mar. 15, 2013

Related U.S. Application Data
(60) Provisional application No. 61/695,360, filed on Aug. 31, 2012.

(51) Int. Cl. H04R 1/02

(52) U.S. Cl. CPC H04R 1/02
USPC 381/351; 381/387; 381/352

(57) ABSTRACT

The invention provides in some aspects a loudspeaker, for example, configured in a band-like shape and suitable, for example, for wearing as a wristband, armband, legband or the like. A related aspect of the invention is to provide such a wearable loudspeaker comprising a band-shaped enclosure, a driver that is mounted in the enclosure, and an active diaphragm that is coupled to the driver to generate sound waves directed outwardly from the enclosure (referred to below as “outwardly directed waves,” “outward waves” and, more often, by analogy to a conventional, non-wearable loudspeaker “frontward-directed sound waves” or, more simply, “front waves”) and backward-directed sound waves (“back waves”) directed inwardly into the enclosure (referred to below as “inwardly directed waves,” “inward waves” and, more often, by analogy to a conventional loudspeaker “backward-directed waves” or, more simply, “back waves”). A reflective member, which is also disposed within the enclosure and/or on an inner surface of a wall thereof, reflects one or more components of the back wave.

This application claims the benefit of priority of U.S. Patent Application Ser. No. 61/695,360, filed Aug. 31, 2012, entitled “WristBand and Other Portable Loudspeakers and Electronic Apparatus Utilizing Same,” and is a continuation-in-part of U.S. patent application Ser. No. 13/557,410, filed Jul. 25, 2012, which claims the benefit of priority of U.S. Patent Application Ser. No. 61/511,210, filed Jul. 25, 2011, both entitled “Ultra-Low Profile Loudspeakers,” the teachings of all of the foregoing of which are incorporated herein by reference.

### BACKGROUND OF THE INVENTION

The invention relates to sound reproduction and, in particular, to improved loudspeakers and electronic devices incorporating same. It has application, by way of non-limiting example, in smart phones, personal digital assistants (“PDAs”), MP3 players, sound cradles, and other handheld, portable and/or electronic apparatus. It has additional application, by way of further non-limiting example, in wearable sound systems—that is, loudspeakers and electronic apparatus incorporating same that can be worn or otherwise carried on the body of a user.

A large percentage of loudspeakers used in audio systems are electrodynamic speakers. They typically comprise drivers that are mounted within enclosures, which may be dedicated housings (such as speaker cabinets) or casings of other devices (such as PDAs) of which the speakers are a part. A driver is usually made of up a magnetic motor that moves a diaphragm to radiate sound. Traditionally, diaphragms are cone-shaped and are disposed within a frame or basket, with the wide and narrow ends of the cone coupled to the frame by way of respective flexible membranes, referred to as the suspension or surround (in the case of the wide end) and the spider (in the case of the narrow end). Those membranes keep the diaphragm axially centered while, at the same time, permitting it move back and forth at audio frequencies.

The motor is made up of a voice coil, which is usually disposed behind the narrow end of the cone, and a magnetic circuit, which is usually disposed adjacent to and/or partially surrounding the coil. In operation, electrical audio signals from an amplifier (or other source) are applied to the voice coil, producing a varying electromagnetic field. This interacts with the magnetic field of the magnet circuit, causing the voice coil to move.

Because the voice coil is coupled to the diaphragm, its movement causes the diaphragm to pump in and out—explaining why the diaphragm and coil are sometimes referred to as a “piston.” That, in turn, causes air around the speaker to pressurize and depressurize, producing sound waves. The enclosure prevents sound waves omitted from the rear of the diaphragm from canceling those emitted from the front. Fabric batting may be provided within the enclosure to neutralize the internally reflected sound waves and to minimize resonances. A port or passive radiator (a/k/a passive diaphragm, e.g., one mounted in a frame, but not coupled to a motor) in the front of the cabinet radiates any of the internally reflected waves not absorbed by the batting, i.e., the lower frequency waves (which are physiologically less distinguishable and, hence, add to the overall fidelity).

Traditionally, speakers are divided into three categories: woofer, midrange and tweeter. The woofer reproduces low frequency (bass) sound ranging from about 20 to 3000 Hz. The midrange speaker reproduces a broad spectrum of sound, typically from about 1000 Hz to 10 kHz. The tweeter speaker reproduces high frequency (treble) sound ranging from about 4 to 20 k Hz. In home audio systems, the woofer, midrange and tweeter are often housed in a single enclosure, as in the case of free-standing or floor speaker configurations. Where space is a consideration, the woofer and midrange may be combined in a single speaker, as in the case with bookshelf-sized speaker configurations.

Indeed, the functions of the woofer, midrange and tweeter may all be combined into one in the case of portable or embedded loudspeakers, e.g., of the type manufactured into smart phones, PDAs, MP3 players, sound cradles, and other handheld, portable and/or electronic apparatus. Unfortunately, it is typically difficult for speakers of this type to reproduce suitably low frequencies at reasonable volumes. In fact, because sounds in the mid-range frequencies are so much more efficiently generated, they tend to dominate small or low-powered speakers, making them sound obnoxiously “tinny.”

Prior innovations by the inventor hereof have brought improvement in this regard.

For example, according to the abstract of U.S. Pat. No. 6,611,606, by the same inventor hereof, a compact high performance loudspeaker utilizes a drive having first and second annular magnets arranged concentrically with each other and connected by a shunt at one end and a pole-defining structure at the other end to concentrate magnetic flux in a cylindrical voice coil gap. The shunt and pole structure are stacked such that the combined magnetic assembly has an opening extending centrally therethrough. The diaphragm of the speaker is said to communicate through the central opening with the volume of the enclosure behind the speaker or the opening is said to serve as a port of the enclosure—allowing further degrees of control over total acoustics.

By way of further example, US Patent Application 2008/0292117, provides loudspeakers and electronic devices with improved radiators (or “passive drivers”) comprising an elastomerically mounted mass in order to improve sound reproduction fidelity. The mass comprises a component of the device not normally used for such purpose—e.g., a battery—thereby, permitting size reductions while, at the same time, enhancing audio fidelity.

Prior to the innovations of the inventor hereof, the art has largely lacked small loudspeakers and, particularly, those suitable for personal use, capable of high fidelity sound reproduction. While earphone makers have had some success in that regard, it has been limited to devices designed to be fitted to users' ears and capable of reproducing sound with fidelity in volumes not substantially larger than the auricle of the ear (in the case of a so-called headphone) or the external auditory canal (in the case of an earphone, earbud or the like). Thus for example, a single earphone (or headphone) is typically unsuitable for playing sound with fidelity to two or more people, even if they are standing next to one another.

The foregoing notwithstanding, there is increased demand for loudspeakers (and/or electronic electronic apparatus that incorporate them) with improved fidelity, smaller size and, in many instances, portability. Such are among the objects of the invention.

A related object is to provide such loudspeakers (electronic apparatus) as can operate at low power.

A still further related object is to provide such portable and/or electronic apparatus as provide high fidelity sound.

A further related object is to provide such loudspeakers and/or electronic apparatus as are suited for use in smart phones phones, PDAs, MP3 players, sound cradles, and other handheld, portable and/or electronic apparatus.

Yet a still further related object is to provide such loudspeakers and/or electronic apparatus as are suited to be worn by a user.

### SUMMARY OF THE INVENTION

The foregoing are among the objects attained by the invention, which provides in some aspects a loudspeaker, for example, configured in a band-like shape and suitable, for example, for wearing as a wristband, armband, legband or the like.

A related aspect of the invention is to provide such a wearable loudspeaker comprising a band-shaped enclosure, a driver that is mounted in the enclosure, and an active diaphragm that is coupled to the driver to generate sound waves directed outwardly from the enclosure (referred to below as “outwardly directed waves,” “outward waves” and, more often, by analogy to a conventional, non-wearable loudspeaker “frontward-directed sound waves” or, more simply, “front waves”) and backward-directed sound waves directed inwardly into the enclosure (referred to below as “inwardly directed waves,” “inward waves” and, more often, by analogy to a conventional loudspeaker “backward-directed waves” or, more simply, “back waves”). A reflective member, which is also disposed within the enclosure and/or on an inner surface of a wall thereof, reflects one or more components of the back wave.

A further related aspect of the invention provides such a wearable loudspeaker having a passive radiator that is disposed on the enclosure and that passes outwardly therefrom one or more components of the back wave reflected by the reflective member. The passive radiator comprises, e.g., according to further aspects of the invention, a mass elastomerically coupled to the enclosure and air-coupled to the diaphragm, e.g., by way of a foam member (see below) and/or the reflective member. That mass comprises, according to further aspects of the invention, an electronic circuit component of the loudspeaker—e.g., a battery of flat and/or planar shape.

Yet a further related aspect of the invention provide such a wearable loudspeaker having foam member, disposed within the enclosure and/or on an inner surface of a wall thereof, that attenuates components of the back wave as a function of frequency, e.g., in the manner of a low-pass filter. The reflective member reflects one or more components of the back wave that have passed through the foam member and that have not been eliminated thereby.

Other aspects of the invention provide a loudspeaker comprising an enclosure, a driver that is mounted in the enclosure, and an active diaphragm that is coupled to the driver to generate frontward-directed sound waves (“front waves”) directed outwardly from the enclosure and backward-directed sound waves (“back waves”) directed inwardly into the enclosure. A foam member, disposed within the enclosure and/or on an inner surface of a wall thereof, attenuates components of the back wave as a function of frequency, e.g., in the manner of a low-pass filter. A reflective member, which is also disposed within the enclosure and/or on an inner surface of a wall thereof, reflects one or more components of the back wave that have passed through the foam member and that have not been eliminated thereby.

Related aspects of the invention provide a loudspeaker, e.g., as described above, in which the foam member comprises a foam of rigid material, namely, by way of example, a foam of metal, ceramic, carbon, silicon, glass, and/or epoxy. It (the foam member) may be disposed adjacent the reflective member and, indeed, together those members may comprise one or more walls of the enclosure, e.g., with the reflective member forming an outer surface of the wall(s) and with the foam member forming an inner surface.

Related aspects of the invention provide a loudspeaker, e.g., as described above, having a passive radiator that is disposed on the enclosure and that passes outwardly therefrom one or more components of the back wave reflected by the reflective member. The passive radiator comprises, e.g., according to further aspects of the invention, a mass elastomerically coupled to the enclosure and air-coupled to the diaphragm, e.g., by way of the foam member and the reflective member. That mass comprises, according to further aspects of the invention, an electronic circuit component of the loudspeaker—e.g., a battery of flat and/or planar shape.

Still further aspects of the invention provide loudspeakers, e.g., as described above, wherein the foam member is thermally conductive and wherein the driver and/or other circuit elements of the loudspeaker (e.g., power, amplification and conditioning circuitry) are mounted to and/or in thermal coupling with the foam member. In related aspects of the invention, such mounting can be via recesses of the foam member.

Yet still further aspects of the invention provide loudspeakers, e.g., as described above, wherein the driver comprises first and second annular magnets positioned coaxially and forming a radial gap therebetween. Those magnets can be, according to related aspects of the invention, axially poled and can have a shunt connected across them. A first such pole piece has a first face and is positioned on the first magnet, while a second pole piece has a second face and is positioned on the second magnet, so as to defines a voice coil gap between the first and second faces such that magnetic flux is focused in the voice coil gap while leaving a central opening.

Related aspects of the invention provide loudspeakers, e.g., as described above, in which the driver comprises a voice coil connected to the active diaphragm and a magnet assembly defining a flux gap, wherein the voice coil is positioned in the flux gap, and wherein the magnet assembly includes a pair of concentrically-disposed annular magnets. A shunt is positioned on one side of the magnets. A pair of pole pieces at a second side of the magnets focus magnetic flux within the gap. The magnets and shunt are, moreover, arranged to form a central opening for air coupling via the foam member.

Further aspects of the invention provide wristbands, armbands, legbands, smart phones, personal digital assistants (“PDAs”), MP3 players, sound cradles, and other handheld, portable and/or electronic apparatus—wearable, portable or otherwise—incorporating loudspeakers of the type described above.

Further aspects of the invention are evident in the drawings and in the discussion that follows.

### BRIEF DESCRIPTION OF THE DRAWINGS

A more complete understanding of the invention may be attained by reference to the drawings, in which:

FIG. 1 depicts a conventional, prior art loudspeaker of the type commercially available in the marketplace;

FIGS. 2A-B depict a loudspeaker according to one practice of the invention;

FIGS. 3A-3B depict a system that includes a loudspeaker according to a practice of the invention;

FIGS. 4A-4D depict a construction of a loudspeaker according to one practice of the invention;

FIG. 5 depicts a diaphragm and driver of the type used in a loudspeaker according to one practice of the invention;

FIG. 6 depicts an electronic apparatus—in this case, an electric guitar—incorporating a loudspeaker according to one practice of the invention;

FIGS. 7A-7B depict a wearable loudspeaker or other electronic apparatus according to the invention; and

FIG. 8 depicts industrial design and other details of the loudspeaker or other electronic apparatus of FIG. 7.

### DETAILED DESCRIPTION OF THE ILLUSTRATED EMBODIMENT

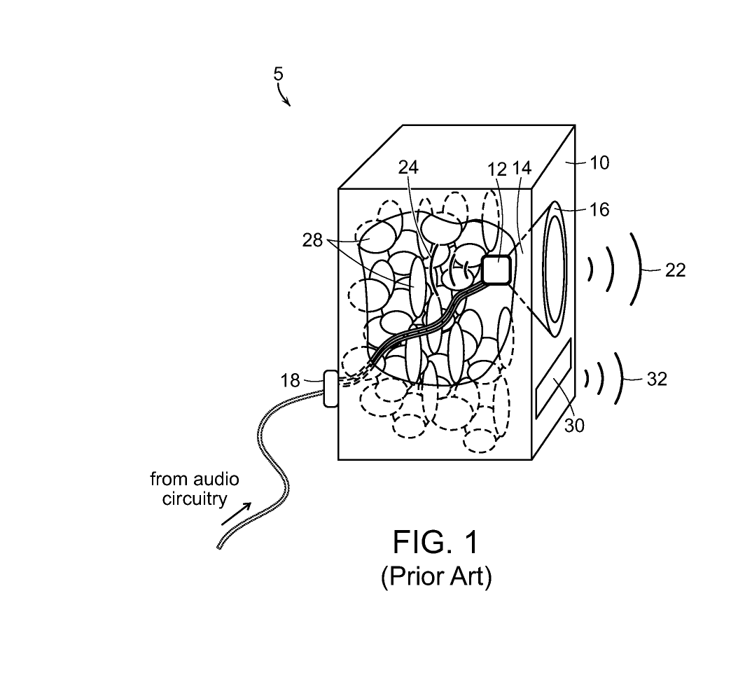

### FIG. 1—Prior Art Loudspeakers

FIG. 1 depicts a conventional, prior art loudspeaker 5 of the type commercially available in the marketplace. The illustrated loudspeaker includes an enclosure 10 that houses a driver comprising motor 12 and diaphragm 14, here, of the cone-shaped variety.

Disposed at the rear (here, the narrow end) of the cone is a voice coil (not shown) that is driven by radio, MP3 or other audio signal-generating circuitry (not shown). That voice coil typically rides (i.e., reciprocates back and forth) in a magnetic field-filled gap defined by a fixed magnetic assembly (not shown) which also forms part of the motor 12.

Though not shown here, the driver is typically mounted in a frame that is affixed at the inside of the enclosure 10. A flexible membrane referred to as a spider couples the narrow, rear end of the cone to the frame, keeping it axially centered while, at the same time, permitting it (and the voice coil) to move back and forth within the field established by the magnetic assembly. Another flexible member, here, surround 16, likewise couples the front (here, the wide end) of the cone to the enclosure, keeping it generally centered while also permitting vibratory movement.

Power circuitry 18 conditions the audio signal received by the loudspeaker from the audio signal-generating circuitry, e.g., via leads 20. That conditioning includes amplification, band-pass filtering, smoothing and so forth, as is common in the art. The circuitry 18 can be externally powered (e.g., from a wall socket) or via a battery (not shown) mounted on/in the enclosure 10.

Because it is coupled to (and, indeed typically attached to) the diaphragm, movement of the voice coil within the magnetic gap causes the diaphragm to piston in and out. as noted above, that in turn causes air around the speaker to pressurize and depressurize, effecting both frontward-directed sound waves, i.e., “front waves” 22, that radiate to listeners (not shown) and rearward-directed waves, i.e., back waves 24, that radiate into the enclosure 10.

To prevent the rearward-directed waves 24 from canceling the frontward-directed ones 22, fabric batting 28 or the like is provided in the enclosure. This attenuates higher frequencies, minimizes internal reflections and reduces resonances.

A port 30 or passive radiator (a/k/a a passive diaphragm, e.g., one mounted in a frame, but not coupled to a motor) in the front of the enclosure 10 radiates frontward, as further front waves 32, any of the internally reflected back waves not absorbed by the batting, i.e., the lower frequency waves.

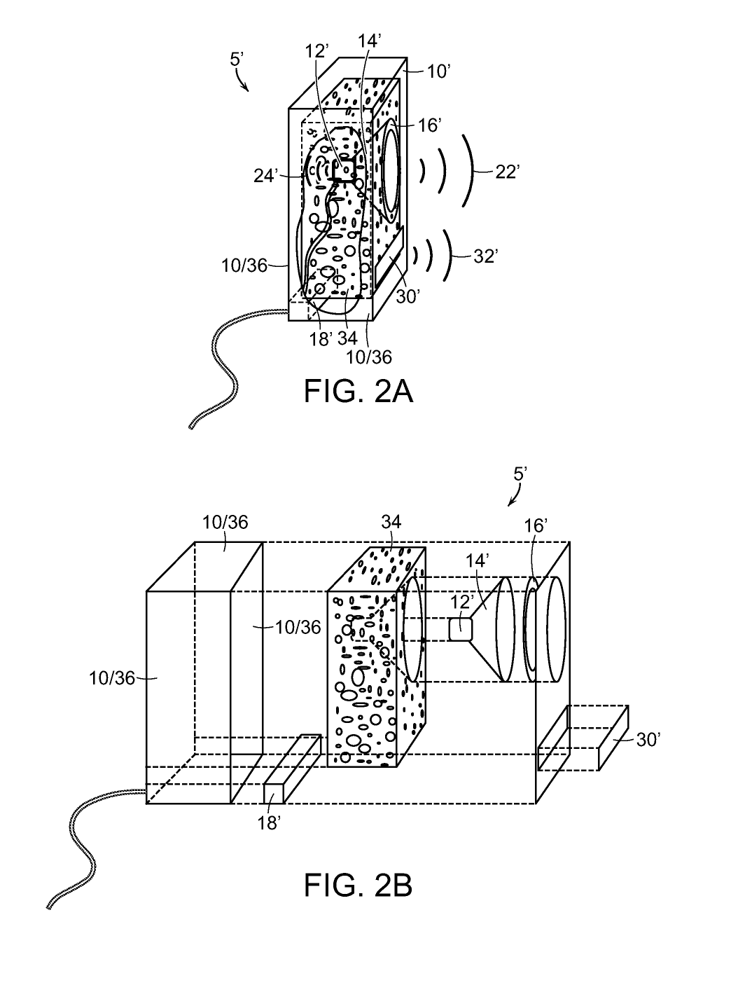

### FIG. 2—Loudspeakers According to the Invention

FIG. 2A is a perspective, see-through view of a loudspeaker according to one practice of the invention. FIG. 2B is a exploded view of that same loudspeaker.

The illustrated loudspeaker 5′ includes an enclosure 10′ that houses a driver including motor 12′ and diaphragm 14′, all of like type and function to like-numbered elements 10, 12, 14, albeit as adapted in accord with the teachings hereof. As above, the diaphragm 14′ may be equipped with a voice coil (not shown) that, too, is driven by radio, MP3 or other audio signal-generating circuitry (not shown), and the driver may be mounted in a frame (not shown) that is affixed at the inside of the enclosure 10′, again, all of like type and function to like-named elements discussed above in connection with FIG. 1, albeit as adapted in accord with the teachings hereof. The illustrated loudspeaker 5′ includes, too, a spider (not shown) and a surround 16′, of the type described above as adapted in accord with the teachings hereof. It also includes power circuitry 18′ of like type and function to like-numbered element 18, again, as adapted in accord with the teachings hereof.

Illustrated speaker 5′ operates in the manner of like-numbered speaker 5, discussed above, as adapted in accord with the teachings hereof. Thus, for example, movement of its voice coil within the gap formed by the motor 12′, causes the diaphragm 14′ to piston in and out, effecting both front waves 22′ that radiate to listeners (not shown) and back waves 24′ that radiate into the enclosure 10′.

Disposed within enclosure 10′ is a metal foam member 34, which inter alia attenuates higher frequencies, minimizes internal reflections and reduces resonances and, thereby, prevents back waves 24′ from canceling the front waves 22′. More generally and/or in addition, the foam member serves as an acoustic low-pass filter that attenuates components of the back wave 24′ as a function of frequency, reducing higher frequency components, while passing lower-frequency ones.

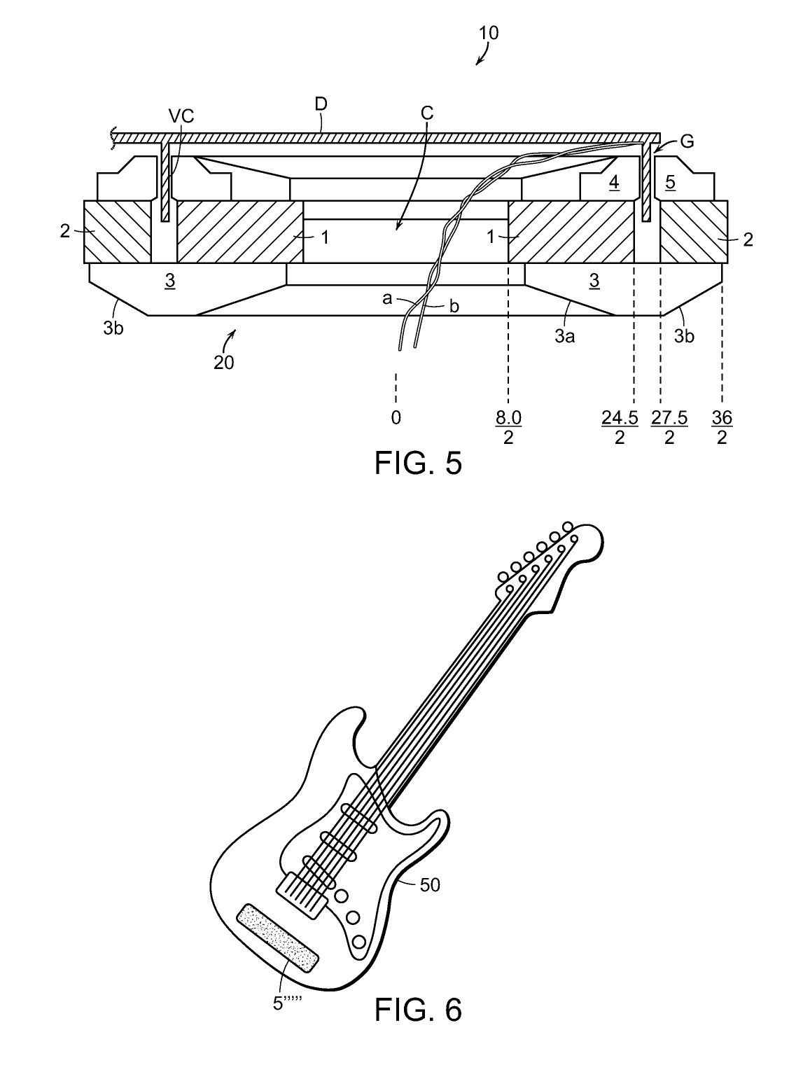

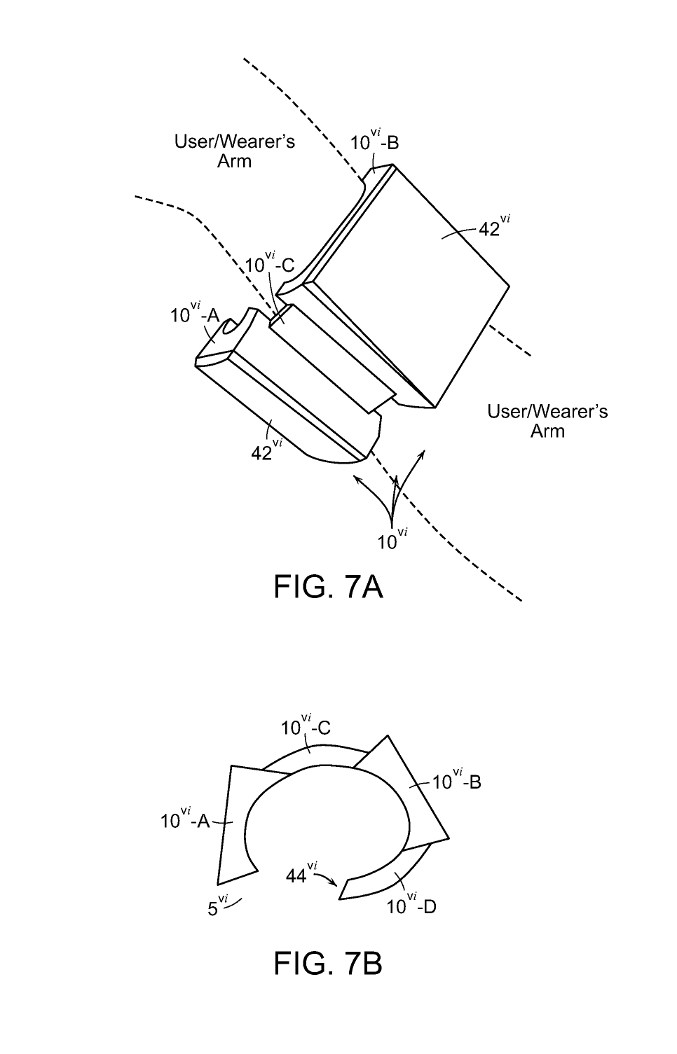

As will be appreciated in view of the embodiments shown and discussed in connection with FIG. 7, et seq., some embodiments of the invention do not utilize a foam member (nor, of course, do they necessarily use one or more of the other elements discussed in connection with the embodiment of FIG. 2, etc.). With respect to those embodiment that do utilize a foam member, its advantages include
replacing speaker box volume and cabinet wall volume loss
very energy absorbent: Better sound due to back waves being fully absorbed and energy converted to heat
excellent heat sink for magnet speakers, e.g., of the type shown in FIG. 5—direct heat transfer from magnet to foam and air to foam
excellent RF shield and heat sink for embedded Class-D amps (e.g., provided in power circuitry 18′). Along with cooled speaker magnets, that power circuitry can be embedded inside speaker driver for best damping, energy transfer, and RF performance. This also has the benefit of eliminating more wires
significant weight reduction as solid material can be up to 90% air! Indeed, due to low density of foam member 34 (even when comprised of aluminum foam), it can float on water
environmental “green”, when compared to other speaker solution of comparable performance.

A reflective member 36′ disposed on or within the enclosure 10′ reflects one or more components of the back wave that have passed through the foam member and that have not been eliminated thereby.

The loudspeaker 5′ further includes a port or passive radiator 30′ of like type and function as like-numbered/-named elements discussed above in connection with FIG. 1, albeit as adapted in accord with the teachings hereof. That port 30′ radiates frontward, as further front waves 32′, any of the internally reflected back waves 24′ not absorbed by the foam member, i.e., the lower frequency waves.

Loudspeaker 5′ also includes power circuitry 18′ of like type and function to like-numbered elements 18, albeit as adapted in accord with the teachings hereof. As above, that circuitry 18′ conditions an audio signal received by the loudspeaker 5′, e.g., from a radio, MP3 player or other audio signal-generating circuitry, e.g., via leads 20′. Alternatively, or in addition, it may receive that signal via WiFi, Bluetooth or other wireless medium. The circuitry 18′, too, can be externally powered (e.g., from a wall socket) or via a battery (not shown).

Although circuitry 18′ can be mounted on the exterior of enclosure 10′, in the illustrated embodiment, it is mounted within the enclosure—and, more specifically, in thermal contact with the foam member 34. As such, it takes advantage of the conductive properties of the foam to draw away heat and, therefor, to avoid thermal destruction of the circuitry 18′ or surrounding components.

Foam Member

In some embodiments—such as that illustrated in FIGS. 2A-2B—the foam member 34 is disposed within that portion of the cavity defined by the walls of the enclosure 10′ not otherwise occupied by the driver, frame or other components of the loudspeaker 5′, preferably, occupying at least 5-20% of the available volume of that cavity; still more preferably, 20-40% of that available volume; yet still more preferably, 40-60% of that available volume; still yet more preferably, 60-80% of that available volume; and yet still yet more preferably 80-100% of that available volume. The foam member 34 may be affixed within the enclosure 10′ by gravity, friction, glues, welding (ultrasonic or otherwise), screws, pins, staples or other means.

In other embodiments, the foam member 34 forms at least part of one or more of the walls of enclosure 10′, likewise, preferably occupying at least 5-20% of the otherwise available volume of with the cavity; still more preferably, 20-40% of that available volume; yet still more preferably, 40-60% of that available volume; still yet more preferably, 60-80% of that available volume; and yet still yet more preferably 80-100% of that available volume.

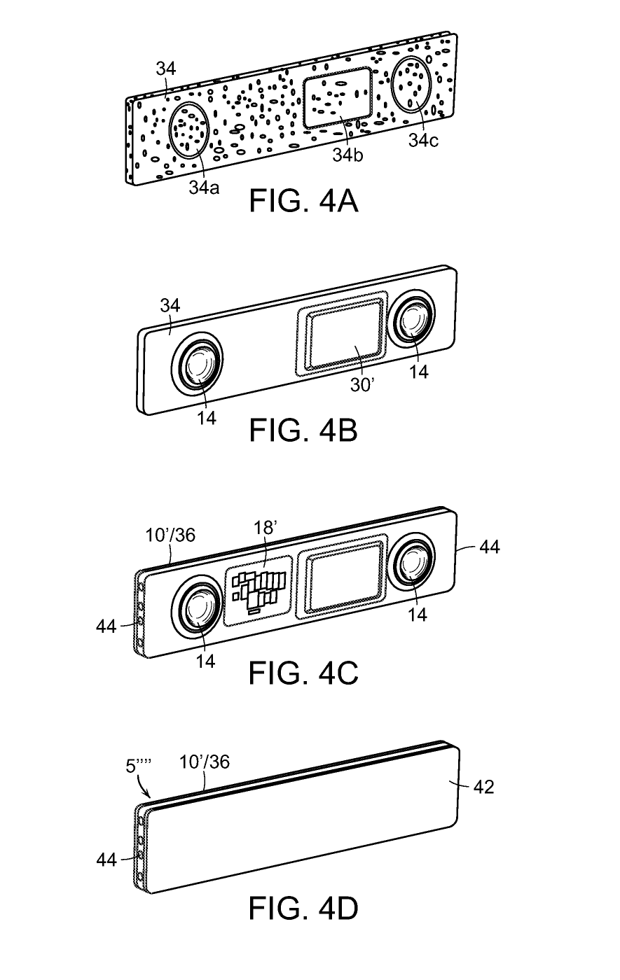

In still other embodiments, the foam member 34 not only defines one or more of the walls of the enclosure 12′ and/or occupies a sizeable portion of the available volume therein, it also substantially defines the cavity itself. Such is characteristic of the embodiment shown in FIG. 4.

In some embodiments, the foam member 34 comprises open-celled aluminum foam of the type commercially available in the marketplace. One preferred such aluminum foam is characterized by open cells and, preferably, open cells that are anisotropically oriented and that have a density of 0.5-0.7 gm/cc. though foams of other densities may be used instead or in addition. As used here, the term “anisotropically oriented” refers to oriented in a variety of different directions—as distinct, for example, from a “honeycomb” configuration, in which the cells are open in substantially the same direction).

In other embodiments, other open-celled metal foams may be utilized. While still in other embodiments, open-celled foams of still other rigid materials may be used, e.g., foams of ceramic, carbon, silicon, glass, and/or epoxy. The porosity (and other characteristics) of these non-aluminum foams may be in accord with the above or otherwise, e.g., as determined empirically or otherwise to achieve the acoustic properties attributed to the foam member 34 described herein.

Benefits of use of the open cell metal foam (in those embodiments that utilize it) are that it can effectively serves as:

1. an enclosure

2. a heat sink for the electrical and electromagnetic components; and/or

3. a cavity of enclosure

Reflective Member

As noted, the reflective member 36 disposed on or within the enclosure 10′ reflects one or more components of the back wave that have passed through the foam member and that have not been eliminated thereby.

In the illustrated embodiment, that member 36 forms walls of the enclosure and is labelled accordingly (i.e., as elements 10′ and 36); though, in other embodiments, the member 36 is disposed within the cavity defined, e.g., by wood, fiberboard, plastic, carbon fiber or other walls of the enclosure. In still other embodiments, the reflective member 36 is not disposed on surface(s) of foam member(s) 34 but, rather, is embedded in them.

Regardless, the member 36 is preferably disposed so that foam member 34 is between it (member 36) and the diaphragm. This maximizes elimination of higher frequencies in the back waves 24′, since they are forced to travel through the foam member 34 before reflection and, again, back through the foam before exiting port 30′.

The reflective member 36 comprises a metal, cardboard, fiberboard, wood, glass, plastic, carbon fiber or other material suitable for reflecting back waves 24′. In embodiments where it forms walls of the enclosure 10′ that are not structurally supported, e.g., by the foam member(s) 34, the structural member 36 is preferably to be sufficiently rigid for intended uses of the loudspeaker 5′. However, where the member 36 is so supported, e.g., by the foam member(s) 24, it need not be so rigid (of it's own) but, rather, can comprise a veneer, skin, shell or other thin layer on the foam member(s)—which, since fabricated from metal or other rigid materials, provides the necessary support for the reflective member.

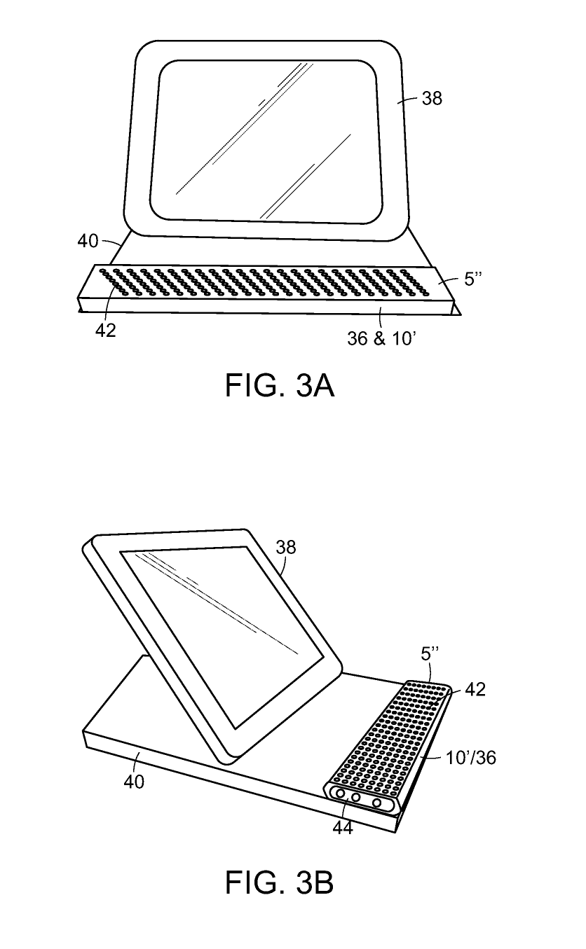

### FIG. 3—Alternate Embodiment

FIGS. 3A-3B depict a system that includes a loudspeaker according to a practice of the invention. The system includes a electronic device 38, a loudspeaker 5″ according to the invention, and stand/carrying case 40.

The electronic device 38 comprises a radio, MP3 player, computer or other device known in the art that includes audio signal-generating circuitry suitable for generating audio signals, as adapted in accord with the teachings hereof. This may be, for example, a desktop computer or shelf-top radio. Preferably, however, it comprises a portable device—such as the tablet computer illustrated here. The device 38 can be equipped with leads 20 for applying those signals to the speaker 5″; however, preferably, the device 38 transmits those signals to the speaker 5″ wireless, e.g., via BlueTooth, WiFi, or otherwise.

The loudspeaker 5″ is generally constructed and operated in the manner of loudspeaker 5′ of FIG. 2. Loudspeaker 5″, however, is an embodiment in which the foam member 34 defines (along with reflective member 36) walls of the enclosure 10′ and substantially defines the cavity defined by those walls such as is more particularly shown in FIG. 4. As such, loudspeaker 5″ can be of small “footprint,” yet, it can generate sound (and, particularly, bass) worthy of a much larger loudspeaker.

As shown in the drawing, the loudspeaker 5″ includes a grill or cover 42. This may be fabric or other material known in the art suitable for protecting the loudspeaker components, while permitting exit of frontward-directed sound waves 22′ and 32′ (see FIG. 2). A preferred such grill or cover comprises a perforated steel foil of 0.1-0.3 mm and, preferably, of about 0.2 mm—though, foils of other materials and/or thicknesses may be used instead or in addition.

Stand/carrying case 40, which is optional in this embodiment, is a conventional device of the type known in the art suitable as a stand and/or carrying case for device 38 and loudspeaker 5″, as adapted in accord with the teachings hereof. Though illustrated here as a “foldable” (e.g., of plastic, leather, and so forth) suitable for serving both functions, in other embodiments it may be of other design suitable for either or both.

Loudspeaker 5″ additionally includes ports 44 for wired coupling of audio signals generated by the electronic device 38, as well as for coupling externally power for circuitry 18′ (see FIG. 2). These and such other additional ports as may be provided are of the conventional variety known in the art as adapted in accord with the teachings hereof.

### FIG. 4—Construction

FIGS. 4A-4D depict a construction of a loudspeaker 5^{iv} according to one practice of the invention and, particularly, a loudspeaker in which the foam member 34 (see FIG. 2) not only occupies substantially all of the volume defined by the enclosure 36′ the volume therein, but also substantially defines the cavity defined by those walls.

### FIG. 4A—Foam Member

Referring to FIG. 4A, there is shown a foam member 34 fabricated in accord with one practice of the invention. The illustrated member 34, which is intended for use with a portable loudspeaker 5^{iv} suitable for use, e.g., in an application of the type shown in FIG. 3, is of a shape matching that of the loudspeaker 5^{iv} to be formed therefrom—here, an elongated, flatted cuboid, or slab. Of course, in other embodiments, the member 34 and/or the loudspeaker 5^{iv} take on other configurations.

As discussed above, the foam member 34 shown here comprises open-celled aluminum foam having a foam density within the ranges discussed above, e.g., in connection with FIG. 2. As noted earlier, other foams with other densities can be used instead. Dimensions of the member 34 vary in accord with those of the loudspeaker 5^{iv}, though, in one embodiment, the member is of dimensions approximately 50 mm×200 mm×4 mm (with a density of 0.5-0.7 gm/cc) and is used with a loudspeaker 5′″ only nominally larger in size vis-a-vis those dimensions.

Illustrated foam member 34 includes one or more recesses (here, recesses 34a, 34c) to accommodate drivers, for example, of the type shown in FIGS. 1, 2, as adapted in accord with the teachings hereof. Other embodiments may incorporate just one such recess and, still others, more than two. Though those two are shown here as being of like size and for accommodating like drivers, in other embodiments, they may differ.

The foam member further includes a recess 34b to accommodate a passive radiator. Other embodiments may incorporate fewer or more recesses for passive radiators and/or may utilize passive radiators of other types.

In the illustrated embodiment, the recesses represent depressions, cut-aways or other regions within the foam member 34 that are of reduced thickness. The depth of depression may vary from embodiment to embodiment, with some embodiments having recesses that extend all the way through the member 34 (and termination, for example, at the reflective member) and other embodiments lacking recesses entirely.

In the illustrated embodiment, the recesses are intended for seating of the respective drivers (in the case of recesses 34a, 34c) and radiators (recess 34b), e.g., to assist in mounting them during transport and operation and to keep them protruding excessively from the assembled device. As such, their depth matches that of the respective drivers or radiator, with sufficient additional clearance to accommodate expected pistoning or other vibration of those components without buzzing or interference of motion.

### FIG. 4B—Drivers

FIG. 4B illustrates foam member 34 of FIG. 4A including drivers 14 and a passive radiator 30′ mounted in recesses 34a-34c. As noted, the drivers 14 may be of the type shown in FIGS. 1, 2. Preferably, however, one or both of these are drivers of the type disclosed in U.S. Pat. No. 6,611,606 and, more specifically, drivers of the sort identified as “speaker 10,” e.g., in FIG. 1 of that patent, and in the accompanying text, the teachings of which patent, figure and text are incorporated herein by reference, and which figure is reproduced as FIG. 5 hereof.

As evident from the cited patent, such drivers 14 (or “speakers”) are characterized, in part, as having a magnetic assembly with first and second annular magnets positioned coaxially and forming a radial gap therebetween, said first and second magnets being axially poled; a shunt connected across one side of said first and second magnets; a first pole piece having a first face, said first pole piece being positioned on the first magnet; a second pole piece having a second face, said second pole piece being positioned on the second magnet; and, wherein the magnetic assembly defining a voice coil gap between the first and second faces such that magnetic flux is focused in said voice coil gap while leaving an opening centrally through said assembly.

Such drivers 14 (or “speakers”) are further characterized, in part, as having a voice coil connected to the active diaphragm, and a magnet assembly defining a flux gap, wherein the voice coil is positioned in the flux gap, said magnet assembly including a pair of concentrically-disposed annular magnets, a shunt positioned on and interconnecting one side of said magnets, and a pair of pole pieces at a second side of said magnets so as to efficiently focus magnetic flux between opposed faces of the pole pieces to form said voice coil gap, the magnets and shunt arranged to form a central opening for air coupling via the foam member.

Of course, it will be appreciated that drivers of other types may be used instead or in addition.

Passive Radiator

Passive radiator 30′ may comprise a port (e.g., an opening) or a passive radiator of the type known in the art, as adapted in accord with the teachings hereof. Preferably, however, the passive radiator is of the type shown in commonly assigned U.S. patent application Ser. No. 11/752,400, Pub. No. US 2008/0292117, (now, U.S. Pat. No. 8,189,840) entitled “Improved Loudspeaker and Electronic Devices Incorporating Same,” and, more specifically, a passive radiator of the type shown, e.g., e.g., in FIG. 2B of that patent application, and in the accompanying text, the teachings of which patent, figure and text are incorporated herein by reference.

As evident from the cited patent application, such a passive radiator comprises an elastomerically mounted mass in order to improve sound reproduction fidelity. The mass comprises a component of the device not normally used for such purpose—in this case a battery for powering circuitry 18′—thereby, permitting size reductions while, at the same time, enhancing audio fidelity.

In some embodiments, such a passive radiator (e.g., of the type disclosed in the cited, incorporated-by-reference patent application utilizes a carbon fiber frame (instead of a steel rfame) and/or overmolds the battery with Santoprene™ or other thermoplastic vulcanizate. These and or other packaging techniques can flatten the battery pack, e.g., to 5.5 mm or less, depending in its power and type.

### FIGS. 4C & 4D—Combined Elements

FIG. 4C depicts combined enclosure and reflective member (denoted 10′ & 36) in which the foam member 34, drivers 14, radiator 30′, power circuitry 18′ and ports 44 are enclosed to form loudspeaker 5^{iv} shown in FIG. 4D.

The combined enclosure/reflective member 10′/36 can be fashioned from metal, carbon fiber or other material suitable for reflecting back waves, as discussed above. Preferably it is sized to form-fit about the foam member 34, with sufficient additional space to accommodate the ports 44, drivers 14, radiator 30′, and power circuitry 18′. As noted above, the enclosure/reflective member 10′/36 can comprise a veneer, skin, shell or other thin layer that is formed integral to the foam member 34—in which case, one or more of the other elements may be exposed or covered by alternate means.

In the illustrated embodiment, the foam member is as thin as 4 mm and the enclosure/reflective member 10′/36 is as thin as 0.3 mm. Other embodiments may utilize foam member(s) and/or reflective member(s), within the ranges discussed elsewhere herein or otherwise.

FIG. 4D depicts the assembled components, which may be affixed by gluing, welding, screws or other fastening techniques known in the art. As shown in the drawing, a grill 42, e.g., of perforated steel foil of 0.1-0.3 mm and, preferably, of about 0.2 mm, can be used to cover the front loudspeaker 5^{iv}. Here, again, a cover of other material, configuration and/or thickness may be used instead or in addition.

### FIG. 5

FIG. 5 depicts a driver of the type disclosed in U.S. Pat. No. 6,611,606 and, more specifically, drivers of the sort identified as “speaker 10,” e.g., in FIG. 1 of that patent, and in the accompanying text, the teachings of which patent, figure and text are incorporated herein by reference.

### FIG. 6

Loudspeakers according to the invention are suitable for stand-alone application, e.g., in configurations of the type shown in FIGS. 2 and 5. They are also suitable for incorporation in smart phones, PDAs, MP3 players, sound cradles, and other handheld, portable and/or electronic apparatus. One example is presented in FIG. 6, showing an electric guitar 50 that includes a loudspeaker 5^{v} constructed in the manner of loudspeakers 5′-5^{iv} discussed above.

Though, shown here, in the body of the guitar 50, the loudspeaker 5^{v} can likewise be placed in the neck or in other suitable locations. Moreover, although only one loudspeaker 5^{v} is shown in the guitar 50, in other embodiments multiple such loudspeakers may be embedded in the instrument.

Moreover, the loudspeaker 5^{v} of a preferred such guitar 50 has the following additional features:
inclusion, in the power circuitry 18′, of logic supporting high performance and high fidelity digital sound
inclusion, in the power circuitry 18′, of digital signal processing (DSP) emulation of different “classic” guitar sounds starting from very pure string vibration (unaltered by resonant woods and shoddy pick ups)
inclusion, in the power circuitry 18′, of logic Wifi/Bluetooth wireless for programming and connect to more powerful main stage sound systems
light-weight construction, resulting from use of aluminum foam in loudspeaker 5^{v} and carbon fiber construction on guitar body, neck, etc.
rechargeable hot-swap Li-Ion battery in passive radiator 30′ (here, of the type shown in incorporated-by-reference U.S. patent application Ser. No. 11/752,400, Pub. No. US 2008/0292117)

In addition, because the guitar 50 incorporates a loudspeaker 5^{v} according to the teachings hereof, it is suitable, when not played, to serve as a full-blown conventional portable or room sound system. Moreover, in some embodiments, the guitar 50 can be made fully water proof.

Though the loudspeaker 5^{v} is shown, here, as part of guitar 50. It will be appreciated that it may be incorporated in other devices, instead or in addition.

### FIG. 7

In addition to the examples discussed in connection with FIGS. 5, 6 and elsewhere herein, loudspeakers according to the invention are suitable as wearable devices. One example is presented in FIG. 7A, showing a perspective view of a loudspeaker 5^{vi} according to the invention with a band-shaped enclosure suitable for wearing as a wristwatch, armband, ankle band, legband, or the like.

The loudspeaker 5^{vi} is generally constructed and operated in the manner of loudspeaker 5′ of FIG. 2. Here, however, the enclosure 10^{vi} of the illustrated embodiment is generally band-shaped so as to fit comfortably around a wrist, arm, ankle, leg or the like. In FIG. 7A, the enclosure is shown closed (or partially closed) about a user's forearm arm, at a position between the wrist and elbow. That enclosure 10^{vi} comprises several compartments: a first compartment 10^{vi}-A that houses one or more drivers 14, a second compartment 10^{vi}-B that houses a passive radiator, and a third compartment 10^{vi}-C that provides mechanical- and air-coupling between the first and second compartments. In other embodiments of the invention, the enclosure 10^{vi} may have a fewer or greater number of compartments and/or a fewer or greater number of electromechanical or other functional components in those compartments.

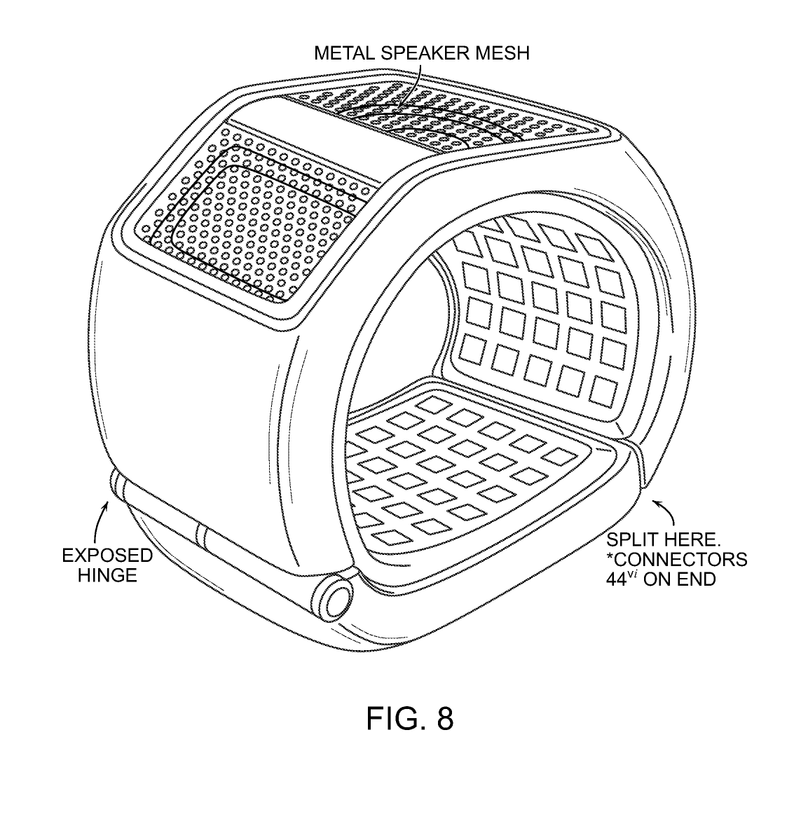

Referring to FIG. 7B, which is a cross-sectional view (along a longitudinal axis of the wearer's arm) of the loudspeaker 5^{vi}, the illustrated embodiment can be seen to include a fourth compartment 10^{vi}-D that rounds-out the band-like shape of the enclosure 10^{vi} (literally and figuratively) and that facilitates holding it to the user's arm, wrist, ankle, leg, or the like. That fourth compartment can be mechanically- and air-coupled to either the first or second compartments and, indeed, in the illustrated embodiment it is so-coupled to only one of those compartments, thereby, leaving a gap in the “band” to facilitate putting-on and taking-off of the loudspeaker 5^{vi} by the wearer. In other embodiments (e.g., as shown in FIG. 8), the fourth compartment may be mechanically- and/or air-coupled to both of those other compartments, with hinge(s) and/or latch(es) provided as necessary for the convenience of the wearer.

As noted, the first compartment 10^{vi}-A houses one or more drivers 14. These may be drivers 14 may be of the type shown in FIGS. 1, 2. Preferably, however, these are drivers of the type discussed in connection with FIG. 4B and, more specifically, drivers of the type disclosed in U.S. Pat. No. 6,611,606 and, more specifically, drivers of the sort identified as “speaker 10,” e.g., in FIG. 1 of that patent, and in the accompanying text, the teachings of which patent, figure and text are incorporated herein by reference, and which figure is reproduced as FIG. 5 hereof

As further noted, the second compartment 10^{vi}-B houses a passive radiator. This may may comprise a port (e.g., an opening) or a passive radiator of the type known in the art, as adapted in accord with the teachings hereof Preferably, however, the passive radiator is of the type discussed in connection with FIG. 4B and, more specifically, of the type shown in commonly assigned U.S. patent application Ser. No. 11/752,400, Pub. No. US 2008/0292117 (now, U.S. Pat. No. 8,189,840) entitled “Improved Loudspeaker and Electronic Devices Incorporating Same,” and, more specifically, a passive radiator of the type shown, e.g., in FIG. 2B of that patent application, and in the accompanying text, the teachings of which patent, figure and text are incorporated herein by reference.

The compartments 10^{vi}-A-10^{vi}-D are themselves enclosures that are air-coupled to each other such that, together, they define an enclosure 10^{vi} that provides for movement of air and sound-waves in the manner of the enclosures of the embodiments described above in connection with FIGS. 2-5. (In the illustrated embodiment, such coupling also accommodates the routing of wiring for electrically coupling the electronic components contained in the compartments). Thus, for example, movement of the voice coil of driver(s) 14 causes its diaphragm to piston in and out, effecting both front waves that radiate to the wearer and other listeners (not shown) and back waves that radiate into the enclosure 10^{vi} and that may traverse one or more of the compartments compartments 10^{vi}-A-10^{vi}-D before being absorbed, attenuated or radiated front-wardly the wearer and other listeners via the passive radiator.

To those ends, the enclosure 10^{vi} and, more particularly, one or more of its constituent compartments 10^{vi}-A-10^{vi}-D may be partially or completely filled with one or more foam members 34. Thus, for example, in one embodiment of the type shown in FIGS. 7A-7B, a plurality of small, discrete foam members are dispersed throughout the enclosure 10^{vi} and, particularly, for example, within the third and fourth compartments 10^{vi}-C, 10^{vi}-D. In other embodiments, the foam member 34 defines (along with reflective member 36) walls of one or more of compartments 10^{vi}-A-10^{vi}-D and substantially the cavities therein in a manner similar to the embodiment discussed in connection with FIG. 3, albeit with overall shape(s) and configuration(s) shown in FIGS. 7A-7B. As noted below, some embodiments eschew such foam members.

Further to the foregoing ends, the enclosure 10^{vi} comprises reflective members that reflect components of the back wave not otherwise absorbed or attenuated (e.g., by a foam member or otherwise). In the illustrated embodiment, those reflective members are walls of the compartments 10^{vi}-A-10^{vi}-D, which may comprise metal, cardboard, fiberboard, wood, glass, plastic, carbon fiber or other material suitable for reflecting back waves. In embodiments, which include foam member(s) 34, the reflective members may comprise surfaces of those or otherwise, e.g., in the manner described in connection with the embodiments of FIGS. 2-5.

The loudspeaker 5^{vi} may include one or more grills 42^{vi} of the type described in connection with FIG. 4D in order to protect the driver and/or the passive radiator.

The loudspeaker 5^{vi} additionally includes ports 44^{vi} for wired coupling of power (e.g., for recharging of a battery (e.g., forming part of the passive radiator in the manner described above and in commonly assigned U.S. patent application Ser. No. 11/752,400, Pub. No. US 2008/0292117, now, U.S. Pat. No. 8,189,840) and other signals necessary or desirable for controlling or configuring the loudspeaker 5^{vi}. In the illustrated embodiment, those ports may be provided at a distal end of the fourth compartment; though, their placement may differ in other embodiments. These and such other additional ports as may be provided are of the conventional variety known in the art as adapted in accord with the teachings hereof.

In addition, such ports can be used to supply audio signals for application to the driver via amplification or other signal processing circuitry of the type known in the art that is contained within one or more of compartments 10^{vi}-A-10^{vi}-D. In most embodiments, however, instead of or in addition to use of ports for such purpose, the loudspeaker 5^{vi} includes antenna (or other sensors) and circuitry that allows it to receive such audio signals wirelessly transmitted from other devices (typically, via WiFi, BlueTooth or other such protocols, though, potentially, via optical transmission schemes).

Though described as a loudspeaker in the text above, the device 5^{vi} can serve other functions instead or in addition. Thus, for example, if equipped with antenna and logic suitable for reception of AM/FM and/or satellite radio signals, it can serve as a portable radio. Likewise, if equipped with a display (e.g., disposed, for example, in a further compartment of the enclosure 10^{vi}) and suitable antenna and logic for reception of television broadcast signals, it can serve as a television. And, by way of further example, if equipped with storage, it can serve as an audio playback unit—and/or, if (also) equipped with a display (e.g., disposed, for example, in a further compartment of the enclosure 10^{vi}) as a audio/video playback unit. By way of still further example, if equipped with environmental and/or physiometric sensors capable of sensing conditions within, or or around the wearer, it can serve as a safety-warning device.

By way of yet still further example, by utilizing BlueTooth or other radio logic suitable for coupling with nearby telecommunications equipment (e.g., a cellular phone in a pocket of the wearer) and a microphone (which can be mounted in one of the compartments), it can serve as a speakerphone and/or, more generally, as a two-way communications device. Likewise, by utilizing WiFi or other radio logic suitable for coupling with IP networks, it can serve as VOIP (voice-over-IP) phone. Alternatively, or in addition, if equipped with antenna and logic suitable for direct connection into the cellular phone networks, it can serve as a portable cellular phone.

FIG. 8 is a photograph depicting further industrial design and other details of a loudspeaker or other electronic apparatus 5^{vi} in accord with the teachings of FIGS. 7A-7B and the accompanying text. The apparatus of FIG. 8 does not utilize foam members 34, though, other embodiments of similar configuration may. Further aspects of the device 5^{vi} are described below:
Bluetooth radio chip set and/or “Wi Fi direct” circuitry for communications coupling with cellular phones and other equipment. The inclusion of Wi Fi Direct overcomes the range (10 meter) and band width limitations of Bluetooth, as well as the time delay of transmission. It makes the device 5^{vi} are a valuable tool for fire fighters, police, traffic cops, sports reporters, restaurant and hospital staff—i.e., whenever the data source is not on your body, as is the case with a cellular phone in the wearer's pocket.
The housing of the first compartment 10^{vi}-A touches the driver 14′ and the air gets channeled through the shallow star grooves of the magnet back plate. This has the added benefit of making that housing stiffer and, thus, permitting the use of thinner metals, plastics, etc., to form walls of that compartment.
A single driver of the type disclosed U.S. Pat. No. 6,611,606 is provided in the first compartment 10^{vi}-A. It has a height of approximately 10 mm for full range bass. Other embodiments could have less height, e.g., through sacrifice of bass.
The housings of the compartments 10vi-A-10vi-D is a carbon fiber-Poly-Imide alloy with extremely high Young's modulus. In spite of its 40% carbon content it can still be molded at a very high temperature near 400 deg C. Utilizing a fast electric molding machine outfitted with hot runners, those housings can be molded as thin a 0.6 mm while having the stiffness of 3 mm aluminum. This carbon fiber-Poly-Imid alloy is electrically conducting and good for cooling as well as shielding.
Electronics housed within the device 5^{vi} include antenna, radio, digital signal processor, battery management, and amplification. These can be housed in the curved part of the compartment 10vi-D on flexible printed circuit board. This would include the BlueTooth antenna and the micro USB 5 Volt charging connector.
To enable use of the antenna, one half of that compartment 10vi-D (or other compartment in which the antenna is house) is electrically non-conducting, e.g., non-military PIE sister material, or ABS PC. It does not need to be stiff or air tight, and could in fact be all Neoprene (e.g., with integrated clasp for diameter adjustment).

Summary

Described herein are loudspeakers and other apparatus meeting the objects set forth above, among others. It will be appreciated that the illustrated embodiment and those described herein are merely examples of the invention and that other embodiments, incorporating changes thereto, fall within the scope of the invention.

Thus, by way of non-limiting example, although some embodiments of the wearable loudspeaker (or other electronic apparatus) shown in FIGS. 7-8 have only a single driver, other embodiments may incorporate multiple drivers, e.g., for reproduction of sound in stereo, surround-sound or the like. Alternatively, or in addition, one or more of such wearable loudspeaker (or other electronic apparatus) may be equipped for pairing with other such loudspeakers (or other electronic apparatus) to simultaneously play (or otherwise coordinate the play of) the same or complimentary channels or other components of an audio signal received by one or more of them. Thus, for example, so paired one such loudspeaker (or other electronic apparatus) disposed on one arm of a wearer and another such loudspeaker (or other electronic apparatus) on another arm of that same (or a nearby) wearer may be capable of reproducing audio signals received by one or both of them in stereo, surround sound or otherwise.

By way of further non-limiting example, although described above as band-like, other wearable loudspeakers (or other electronic apparatus) in accord with the invention can have other shapes suitable for wearing, e.g., helmet shapes for wearing on the head, pendant shapes for wearing like jewelry, full or partial glove or shoe shapes for wearing on extremities, and so forth.

In view of the foregoing, what I claim is:

1. A wearable loudspeaker.

2. A wearable loudspeaker of configured with a band-like shape.

3. The wearable loudspeaker of claim 1 suitable for wearing as a wristband, armband, legband or the like.

4. A loudspeaker comprising
A. a band-shaped enclosure,
B. a driver mounted in the enclosure, and
C. an active diaphragm coupled to the driver to generate sound waves directed outwardly from the enclosure (“front waves”) and backward-directed sound waves (“back waves”) directed inwardly into the enclosure (“back waves”).

5. The loudspeaker of claim 4, comprising a reflective member disposed within the enclosure and/or on an inner surface of a wall thereof that reflects one or more components of the back waves.

6. The loudspeaker of claim 4, comprising a passive radiator that is disposed in and/or on the enclosure and that passes outwardly therefrom one or more components of the back wave reflected by the reflective member.

7. The loudspeaker of claim 6, wherein the passive radiator comprises a mass elastomerically coupled to the enclosure and air-coupled to the diaphragm.

8. The loudspeaker of claim 7, wherein the mass comprises an electronic circuit component of the loudspeaker.

9. The loudspeaker of claim 8, wherein the electronic circuit component comprises a battery.

10. The loudspeaker of claim 4, comprising a foam member disposed within the enclosure and/or on an inner surface of a wall thereof that attenuates components of the back wave as a function of frequency.

11. The loudspeaker of claim 10, wherein the foam member functions as a low-pass filter.

12. The loudspeaker of claim 10, wherein a reflective member reflects one or more components of the back wave that have passed through the foam member and that have not been eliminated thereby.

13. The loudspeaker of claim 3, wherein the enclosure comprises a plurality of compartments, at least a first of which contains the driver and on a wall of which is mounted the active diaphragm.

14. The loudspeaker of claim 6, wherein the enclosure comprises a plurality of compartments, at least a first of which contains the driver and on a wall of which is mounted the active diaphragm, and at least a second of which has mounted on a wall thereof the passive radiator, wherein the first and second compartments are coupled for an exchange of air therebetween (“air-coupled”).

15. The loudspeaker of claim 14, wherein the first and second compartments are mechanically coupled.

16. The loudspeaker of claim 14, comprising a third compartment that is disposed between and air-coupled and mechanically-coupled the first and third compartments.

17. The loudspeaker of claim 13, where one or more of the compartments comprise a foam member disposed within the enclosure and/or on an inner surface of a wall thereof that attenuates components of the back wave as a function of frequency.

18. A loudspeaker in accord of claim 1, equipped and configured as a speakerphone.

19. A loudspeaker in accord of claim 1, equipped and configured as a two-way communications device.

20. A loudspeaker in accord with claim 1, equipped and configured as a safety device.

21. A loudspeaker in accord with claim 1, equipped and configured as an audio playback device.

22. A loudspeaker in accord with claim 1, equipped and configured as an audiovideo playback device.

23. A loudspeaker in accord with claim 1, equipped and configured as a radio.

24. A plurality of loudspeakers or other electronic apparatus in accord with claim 1 paired for coordinated playback of the same and/or complimentary components of the same audio signal.

25. Methods of construction and/or operation of loudspeakers or other electronic apparatus in accord with claim 1.
